(19) United States
(12) Patent Application Publication
(10) Pub. No.: US 2017/0267150 A1
(43) Pub. Date: Sep. 21, 2017

(54) TRUCK RAMP FOR PICKUP TRUCKS

(71) Applicant: Allan Bergen, Drake (CA)

(72) Inventor: Allan Bergen, Drake (CA)

(21) Appl. No.: 15/134,728

(22) Filed: Apr. 21, 2016

(30) Foreign Application Priority Data
Mar. 17, 2016 (CA) 2924203

(51) Int. Cl. B60P 1/43; B65G 67/02

(52) U.S. Cl. CPC B60P 1/431; B65G 67/02

(57) ABSTRACT

A ramp apparatus for a pickup truck includes a housing extending from a front wall to a rear end of the floor and defines an opening in a rear end thereof. Right and left ramp assemblies each include a tailgate section with a length equal to a height of the tailgate, and an inclined section. Each ramp assembly is movable to a retracted position where the tailgate section telescopes inside the inclined section and the ramp assembly is entirely contained in the housing, and from the retracted position to an extended position where the tailgate section extends generally horizontally and a front end of the tailgate section is secured at a rear end of the housing, a rear end of the tailgate section is pivotally attached to a front end of the inclined section, and a rear end of the inclined section rests on a ground surface.

### RELATED APPLICATIONS

This application claims the benefit of Canadian Application No. 2,924,203, filed Mar. 17, 2016, said prior application being hereby fully incorporated by reference herein.

### TECHNICAL FIELD

This disclosure relates to the field of transportation equipment and in particular a ramp assembly for pickup trucks to allow loading all-terrain vehicles (ATVs), snowmobiles, and the like in the box of such pickup trucks.

### BACKGROUND

As fore and aft seating has become prevalent in pickup trucks the length of the truck boxes of pickup trucks has become shorter. A typical pickup truck box from thirty years ago would be about eight feet long while now a typical box length is five and one half to six and one half feet. While there may be room, especially with the tailgate down, to carry and ATV, snowmobile or the like, conveniently carrying loading ramps with a sufficient length to safely load such vehicles is problematic.

U.S. Pat. No. 6,042,923 to Lewis and U.S. Pat. No. 6,880,194 to O'Donnell, et al. disclose a ramp assembly with a housing that generally covers the floor of a pickup truck box. A pair of side-by-side ramps slide in and out of the housing and the top surface of the housing is flat and constructed to support a loaded vehicle. The ramps include a tailgate section that extends horizontally from the housing over the tailgate, and an inclined section pivotally attached to the tailgate section so that the outer end of the inclined section can be lowered to rest on the ground.

U.S. Pat. No. 7,524,156 to Garbes discloses a similar ramp assembly that includes a telescoping inclined ramp section that allows the inclined section to be extended to provide a longer inclined ramp and thus a reduced angle of incline for safer vehicle loading.

### SUMMARY

The present disclosure provides a ramp apparatus for pickup trucks that overcomes problems in the prior art.

In a first embodiment the present disclosure provides a ramp apparatus for a pickup truck box. The apparatus comprising a housing adapted to be mounted on a box floor of the truck box between wheel wells of the truck box, the housing extending substantially from a front box wall to a rear end of the box floor adjacent to a tailgate of the truck box, the housing defining an opening in a rear end thereof, and having a substantially planar top surface configured to support a load. Right and left ramp assemblies each include a tailgate section with a length substantially equal to a height of the tailgate, and an inclined section. Each ramp assembly is movable to a retracted position inside the housing where the tailgate section telescopes inside a forward portion of the inclined section and the ramp assembly is entirely contained in the housing, and each ramp assembly is movable from the retracted position to an extended position where the tailgate section extends generally horizontally and a front end of the tailgate section is secured at a rear end of the housing, a rear end of the tailgate section is pivotally attached to a front end of the inclined section, and a rear end of the inclined section rests on a ground surface.

In a second embodiment the present disclosure provides a pickup truck box ramp apparatus. The apparatus comprises a truck box including a substantially planar box floor, a front box wall extending upward from a front end of the box floor, and a rear tailgate pivotally attached to the truck box at a rear end of the box floor about a gate pivot axis oriented substantially horizontally and parallel to the front box wall such that the tailgate can move from a lowered open position, extending rearward with a top surface thereof substantially aligned with the box floor, to raised closed position with the top surface thereof extending upward from the rear end of the box floor. A housing extends substantially from the front end to the rear end of the box floor, the housing defining an opening in a rear end thereof, and having a substantially planar top surface configured to support a load. Right and left ramp assemblies each include a tailgate section with a length substantially equal to a height of the tailgate, and an inclined section. Each ramp assembly is movable to a retracted position inside the housing where the tailgate section telescopes inside a forward portion of the inclined section and the ramp assembly is entirely contained in the housing, and each ramp assembly is movable, when the tailgate is in the open position, from the retracted position to an extended position where the tailgate section extends generally horizontally over the tailgate and a front end of the tailgate section is secured at a rear end of the housing, and where a rear end of the tailgate section is pivotally attached to a front end of the inclined section, such that the inclined section slopes rearward and downward to a rear end thereof resting on a ground surface.

In a third embodiment the present disclosure provides a ramp apparatus for a pickup truck box. The apparatus comprises a housing adapted to be mounted on a box floor of the truck box between wheel wells of the truck box, the housing extending substantially from a front box wall to a rear end of the box floor adjacent to a tailgate of the truck box, the housing defining an opening in a rear end thereof, and having a substantially planar top surface configured to support a load. A ramp assembly includes a tailgate section with a length substantially equal to a height of the tailgate, and an inclined section. The ramp assembly is movable to a retracted position inside the housing where the tailgate section telescopes inside a forward portion of the inclined section and the ramp assembly is entirely contained in the housing, and the ramp assembly is movable from the retracted position to an extended position where the tailgate section extends generally horizontally and a front end of the tailgate section is secured at a rear end of the housing, a rear end of the tailgate section is pivotally attached to a front end of the inclined section, and a rear end of the inclined section rests on a ground surface.

The present disclosure thus provides a ramp apparatus with the desirable feature of a tailgate section extending over the tailgate to protect the tailgate, and an inclined ramp section with a length that can be as long as the truck box floor, or made significantly longer than the truck box floor to provide a relatively lower angle of inclination to improve safety when driving vehicles up the ramp assembly. Closing the tailgate secures the ramp assemblies in the housing.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an embodiment of the ramp apparatus of the present disclosure mounted in a pickup truck box, and with ramp assemblies thereof in the retracted position and the tailgate of the truck box in the raised closed position;

FIG. 2 is a schematic top view of the embodiment of FIG. 1, and with ramp assemblies thereof in the extended position and the tailgate of the truck box in the lowered open position;

FIG. 3 is a schematic side view of the embodiment of FIG. 1, and with ramp assemblies thereof in the extended position and the tailgate of the truck box in the lowered open position;

FIG. 4 is a schematic top view of the embodiment of FIG. 1 with top of the housing removed to show the configuration of the ramp assemblies, and where the left ramp assembly is in the retracted position and the right ramp assembly is in the extended position;

FIG. 5 is a schematic sectional side view of a ramp assembly of the embodiment of FIG. 1 in the retracted position inside the housing;

FIG. 6 is a schematic sectional side view of a ramp assembly of the embodiment of FIG. 1 in the extended position;

FIG. 7 is a schematic top view of an alternate embodiment of the ramp apparatus of the present disclosure mounted in a pickup truck box where the inclined section includes telescoping segments, and the ramp assembly is shown in the extended position;

FIG. 8 is a schematic sectional side view of a ramp assembly of the embodiment of FIG. 7 in the retracted position inside the housing.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

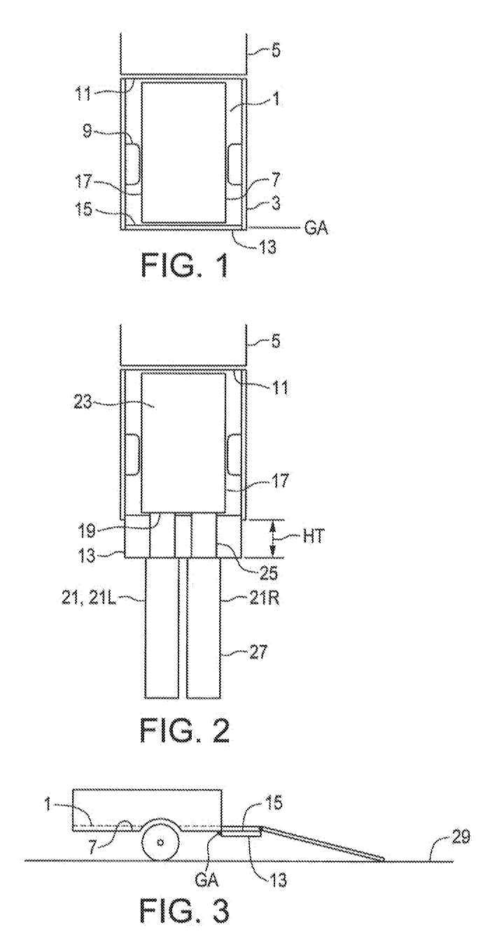

FIGS. 1-6 schematically illustrate an embodiment of a pickup truck box ramp apparatus 1 of the present disclosure mounted in the truck box 3 of a typical pickup truck 5 with a substantially planar box floor 7. Fleet side style pickup trucks 5 have wheel wells 9 extending upward on each side of the box 3, with a planar floor between the wheel wells 9. In step side style pickup trucks the wheel wells are outside the box and the box then has simply a rectangular planar floor. The fleet side style is more common and so has been illustrated however a ramp apparatus 1 of the present disclosure can be fitted in either style.

A front box wall 11 extends upward from a front end of the box floor 7, and a rear tailgate 13 is pivotally attached to the truck box 3 at a rear end of the box floor 7 about a gate pivot axis GA oriented substantially horizontally and parallel to the front box wall 11 such that the tailgate 13 can move from a lowered open position illustrated in FIG. 2, extending rearward with a top surface 15 thereof substantially aligned with the box floor 7, to a raised closed position illustrated in FIG. 1 with the top surface 15 thereof extending upward from the rear end of the box floor 7.

The apparatus 1 comprises a housing 17 adapted to be mounted on the box floor 7 between the wheel wells 9 by bolts or the like fastening same to the box floor. The housing 17 extends substantially from the front box wall 11 to the rear end of the box floor 7 adjacent to the tailgate 13. The housing 17 defines an opening 19 in a rear end thereof to accommodate right and left ramp assemblies 21R, 21L which slide into and out of the housing 17. The housing 17 also has a substantially planar top surface 23 configured to support a load such as an ATV, snowmobile or the like.

The ramp assemblies 21 each includes a tailgate section 25 with a length substantially equal to a height HT of the tailgate 13, and an inclined section 27. The tailgate section 25 is somewhat narrower than the ramp section 27 such that each ramp assembly 21 is movable to a retracted position inside the housing 17, as shown in FIGS. 1 and 5, where the tailgate section 25 telescopes inside a forward portion of the inclined section 27 and the ramp assembly 21 is entirely contained in the housing 17. In this position the tailgate 13 can be raised to the closed position of FIG. 1.

Each ramp assembly 21 is movable, when the tailgate 13 is in the lowered open position, from the retracted position of FIG. 1 to an extended position shown in FIGS. 2 and 3 where the tailgate section 21 extends generally horizontally over the tailgate 13 and a front end of the tailgate section 21 is secured at a rear end of the housing 17, and where a rear end of the tailgate section 21 is pivotally attached about a ramp pivot axis RA, which is substantially parallel to the gate pivot axis GA, to a front end of the inclined section 27, such that the inclined section 27 slopes rearward and downward to a rear end thereof resting on a ground surface 29.

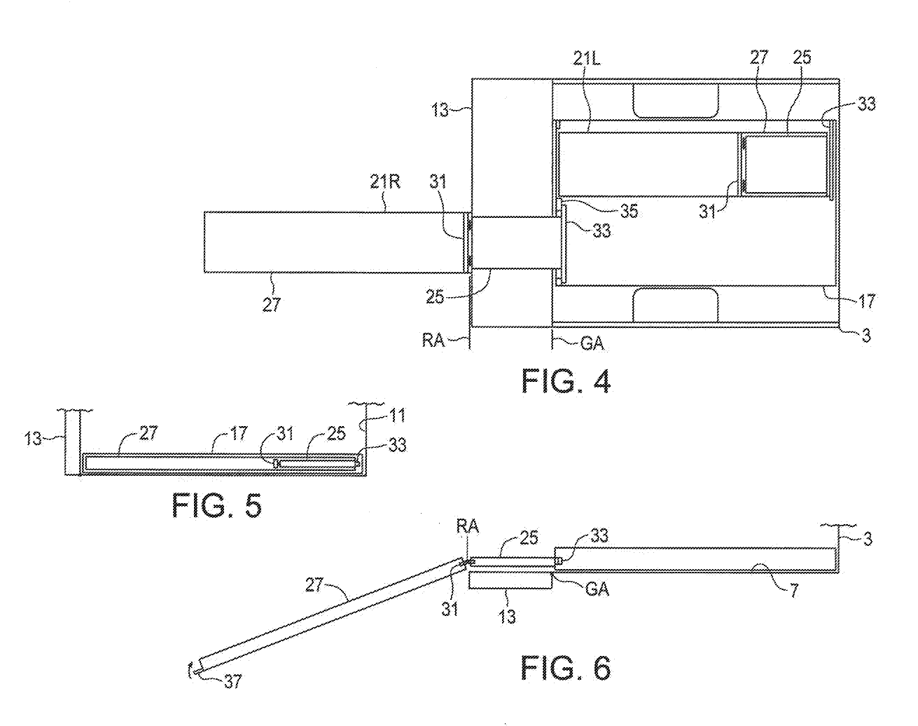

In the illustrated apparatus 1, as best seen in FIG. 4 where the top of the housing 17 is removed, each tailgate section 25 is pivotally attached at a rear end thereof to a hinge bar 31 about a ramp pivot axis RA, and the hinge bar 31 is slidable inside the forward portion of the inclined section 27. When the tailgate 13 is in a lowered open position, and when each ramp assembly 21 is in the extended position, the corresponding ramp pivot axis RA is rearward of a rear end of the tailgate 13 so that the ramp section 27 is free to pivot downward.

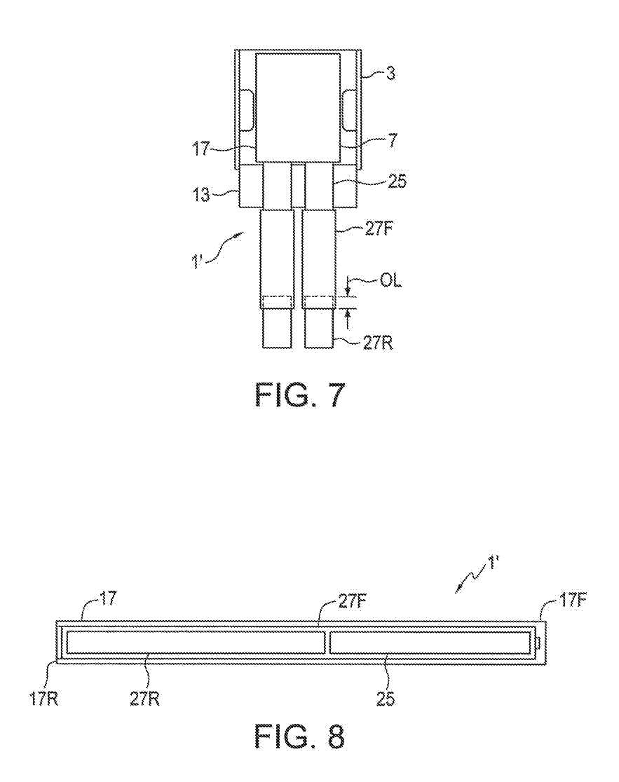

Also as best seen in FIG. 4, in the illustrated apparatus 1 each tailgate section 25 includes a securing bar 33 extending from sides of the tailgate section 25 at a front end thereof. Each securing bar 33 is configured to engage stops 35 attached to the housing 17 when the corresponding ramp assembly 21 is in the extended position.

Where the truck box 3 has a relatively short floor 7, the inclined section 27 of each ramp assembly can include a rear segment 27R telescopically engaged inside a front segment 27F as schematically illustrated in the ramp assembly 1′ of FIGS. 7 and 8. When in the retracted position as seen in FIG. 8, the front segment 27F of the inclined section can be configured, to maximize the length of the inclined section 27, to extend substantially from a front end 17F to a rear end 17R of the housing 17. The tailgate section 25 is inside a forward portion of the front segment 27F of the inclined section 27, and the rear segment 27R is inside a rearward portion of the front segment 27F of the inclined section 27. To maximize the length of the inclined section 27 the rear end of the tailgate section 25 is in close proximity to a front end of the rear segment 27R such that the length of the rear segment 27R is substantially equal to a length of the front segment 27F less a length of the tailgate section 25.

With this configuration, in a short pickup truck box such as those that are known with a length of 66 inches, the front segment 27F of the inclined section 27 can be about 66 inches long. The tailgate section 25 will be 24 inches long, and the rear segment 27R can be about 66−24=42 inches long. When in the extended position then the inclined section 27 will be about 66+42=108 inches, less the required overlap length OL in the telescoping relationship of the front and rear segments 27F, 27R required to provide sufficient strength to the inclined section to bear the contemplated load. Using a 12 inch overlap length OL will still provide a inclined section length of 96 inches. The above lengths are nominal to give a schematic indication of the significant length that can be packed into the housing, and will vary somewhat depending on the pivotal connection means between the tailgate section 25 and inclined section 27, and like practical factors.

A handle 37, as seen in FIG. 6, can be pivotally mounted on the rear end of the inclined section 27 of each ramp assembly 21 to conveniently draw each ramp assembly 21 out of the housing 17. The handles 37 can be pivotally attached so same can be folded up such that the tailgate 13 can be raised to the closed position.

It is also contemplated that instead of right and left ramp assemblies 21R, 21L, a single ramp assembly with a width about the same as the width of the housing 17 could be used however same would be quite heavy and difficult to extend and retract and so using the right and left ramp assemblies 21R, 21L will generally be more convenient.

The present disclosure thus provides a ramp apparatus with the desirable feature of a tailgate section 25 extending over the tailgate 13, and an inclined ramp section 27 with a length that can be as long as the truck box floor 7, or made longer than the truck box floor 7 to provide a relatively lower angle of inclination to improve safety when driving vehicles up the ramp assembly.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

What is claimed is:

1. A ramp apparatus for a pickup truck box, the apparatus comprising:
a housing adapted to be mounted on a box floor of the truck box between wheel wells of the truck box, the housing extending substantially from a front box wall to a rear end of the box floor adjacent to a tailgate of the truck box, the housing defining an opening in a rear end thereof, and having a substantially planar top surface configured to support a load;
right and left ramp assemblies each include a tailgate section with a length substantially equal to a height of the tailgate, and an inclined section;
wherein each ramp assembly is movable to a retracted position inside the housing where the tailgate section telescopes inside a forward portion of the inclined section and the ramp assembly is entirely contained in the housing; and
wherein each ramp assembly is movable from the retracted position to an extended position where the tailgate section extends generally horizontally and a front end of the tailgate section is secured at a rear end of the housing, a rear end of the tailgate section is pivotally attached to a front end of the inclined section, and a rear end of the inclined section rests on a ground surface.

2. The apparatus of claim 1 wherein each tailgate section is pivotally attached at a rear end thereof to a hinge bar about a ramp pivot axis, and wherein the hinge bar is slidable inside the forward portion of the inclined section.

3. The apparatus of claim 2 wherein, when the housing is mounted in a truck box with the tailgate thereof in a lowered open position, and when each ramp assembly is in the extended position, the corresponding ramp pivot axis is rearward of a rear end of the tailgate.

4. The apparatus of claim 1 wherein each tailgate section includes a securing bar extending from sides of the tailgate section at a front end thereof, the securing bar configured to engage stops attached to the housing when the corresponding ramp assembly is in the extended position.

5. The apparatus of claim 1 wherein the inclined section of each ramp assembly includes a rear segment telescopically engaged inside a front segment.

6. The apparatus of claim 3 wherein, when in the retracted position, in each ramp assembly the front segment of the inclined section extends substantially from a front end to a rear end of the housing, the tailgate section is inside a forward portion of the front segment of the inclined section, and the rear segment is inside a rearward portion of the front segment of the inclined section.

7. The apparatus of claim 6 wherein, when in the retracted position, in each ramp assembly the rear end of the tailgate section is in close proximity to a front end of the rear segment.

8. The apparatus of claim 7 wherein a length of the rear segment is substantially equal to a length of the front segment less a length of the tailgate section.

9. The apparatus of claim 1 further comprising a handle mounted on the rear end of the inclined section of each ramp assembly.

10. A pickup truck box ramp apparatus, the apparatus comprising:
a truck box including a substantially planar box floor, a front box wall extending upward from a front end of the box floor, and a rear tailgate pivotally attached to the truck box at a rear end of the box floor about a gate pivot axis oriented substantially horizontally and parallel to the front box wall such that the tailgate can move from a lowered open position, extending rearward with a top surface thereof substantially aligned with the box floor, to raised closed position with the top surface thereof extending upward from the rear end of the box floor;
a housing extending substantially from the front end to the rear end of the box floor, the housing defining an opening in a rear end thereof, and having a substantially planar top surface configured to support a load;
right and left ramp assemblies each including a tailgate section with a length substantially equal to a height of the tailgate, and an inclined section;
wherein each ramp assembly is movable to a retracted position inside the housing where the tailgate section telescopes inside a forward portion of the inclined section and the ramp assembly is entirely contained in the housing; and
wherein each ramp assembly is movable, when the tailgate is in the open position, from the retracted position to an extended position where the tailgate section extends generally horizontally over the tailgate and a front end of the tailgate section is secured at a rear end of the housing, and where a rear end of the tailgate section is pivotally attached to a front end of the inclined section, such that the inclined section slopes rearward and downward to a rear end thereof resting on a ground surface.

11. The apparatus of claim 10 wherein each tailgate section is pivotally attached at a rear end thereof to a hinge bar about a ramp pivot axis, and wherein the hinge bar is slidable inside the forward portion of the inclined section.

12. The apparatus of claim 11 wherein, when each ramp assembly is in the extended position, the corresponding ramp pivot axis is rearward of a rear end of the tailgate.

13. The apparatus of claim 10 wherein each tailgate section includes a securing bar extending from sides of the tailgate section at a front end thereof, the securing bar configured to engage stops attached to the housing when the corresponding ramp assembly is in the extended position.

14. The apparatus of claim 10 wherein the inclined section of each ramp assembly includes a rear segment telescopically engaged inside a front segment.

15. The apparatus of claim 14 wherein, when in the retracted position, in each ramp assembly the front segment of the inclined section extends substantially from a front end to a rear end of the housing, the tailgate section is inside a forward portion of the front segment of the inclined section, and the rear segment is inside a rearward portion of the front segment of the inclined portion.

16. The apparatus of claim 15 wherein, when in the retracted position, in each ramp assembly the rear end of the tailgate section is in close proximity to a front end of the rear segment.

17. The apparatus of claim 16 wherein a length of the rear segment is substantially equal to a length of the front segment less a length of the tailgate section.

18. The apparatus of claim 10 further comprising a handle mounted on the rear end of the inclined section of each ramp assembly.

19. A ramp apparatus for a pickup truck box, the apparatus comprising:
a housing adapted to be mounted on a box floor of the truck box between wheel wells of the truck box, the housing extending substantially from a front box wall to a rear end of the box floor adjacent to a tailgate of the truck box, the housing defining an opening in a rear end thereof, and having a substantially planar top surface configured to support a load;
a ramp assembly including a tailgate section with a length substantially equal to a height of the tailgate, and an inclined section;
wherein the ramp assembly is movable to a retracted position inside the housing where the tailgate section telescopes inside a forward portion of the inclined section and the ramp assembly is entirely contained in the housing; and
wherein the ramp assembly is movable from the retracted position to an extended position where the tailgate section extends generally horizontally and a front end of the tailgate section is secured at a rear end of the housing, a rear end of the tailgate section is pivotally attached to a front end of the inclined section, and a rear end of the inclined section rests on a ground surface.
